(19) United States
(12) Patent Application Publication
(10) Pub. No.: US 2015/0232644 A1
(43) Pub. Date: Aug. 20, 2015

(54) PRODUCTS WITH IMPROVED NON-FLAMMABILITY

(71) Applicant: Bayer MaterialScience AG, Leverkusen (DE)

(72) Inventors: Udo Ahlborn, Burscheid (DE); Klaus Horn, Dormagen (DE); Ciro Piermatteo, Olgiate Olona (VA) (IT); Matthias Rothe, Leverkusen (DE)

(21) Appl. No.: 14/421,483

(22) PCT Filed: Aug. 13, 2013
(86) PCT No.: PCT/EP2013/066935

§ 371 Date: Feb. 13, 2015

(30) Foreign Application Priority Data
Aug. 17, 2012 (IT) RM2012A000414

(51) Int. Cl. C08K 5/3475; C08K 5/11; A47C 5/12; C08K 5/134

(52) U.S. Cl. CPC C08K 5/3475; C08K 5/134; C08K 5/11; A47C 5/12

(57) ABSTRACT

The present invention relates to polycarbonate compositions for producing halogen-free moulded parts for use in public facilities which meet the corresponding fire protection regulations and standards. The present invention also relates to the use of halogen-free polycarbonate compositions for producing moulded parts, particularly seating and/or parts of seating, e.g. seat shells, which are flame-retardant and meet the standards for use in public buildings, as well as the moulded parts themselves.

The present invention relates to polycarbonate compositions for producing halogen-free moldings for utilization in public facilities that meet the appropriate fire prevention stipulations and standards. The present invention further relates to the use of halogen-free polycarbonate compositions for producing moldings, especially seating and/or parts of seating, e.g., seat shells, which are flame-retardant and which meet the standards for use in public buildings, and also to the moldings themselves.

As a result of the outstanding properties of plastics, such as low density, for example, and transparency and toughness coupled with thermoplastic deformability, ensuring high design freedom with low machining costs, plastics are increasingly being utilized for the production not only of design pieces but also of everyday articles. The manufacturers of the moldings are able accordingly to differentiate themselves from their competitors by their own design, with the molding materials for producing design moldings often being highly transparent or having transparent coloration.

Because of the generally good flammability of plastics, however, it is often necessary to add flame retardants and flame retardancy synergists to them, in order to meet the statutory strictures on the use of these articles, especially in public buildings.

A disadvantage where adding these flame retardants, however, is that oftentimes the good mechanical, optical (transparency), and electrical properties of the plastics used are adversely affected, or else that they contain halogen-containing flame retardants.

For the use of plastics and moldings produced from them in public buildings it is necessary that they pass the standardized fire prevention tests and are preferably halogen-free, thereby minimizing exposure to halogenated hydrocarbons, such as dioxins, in the event of fire. The respective standards are country-specific and often very different. Public corporations nowadays therefore only approve moldings which have not been given a flame-retardant treatment using halogen-containing flame retardants, but which nevertheless meet the fire prevention requirements.

Combinations of tetrabromobisphenol A oligocarbonate, alkali metal or alkaline earth metal salts of perfluoroalkanesulfonic acids and bisphenol A polycarbonate are described in US 2009/0043023. The bromine-containing flame retardancy additive is used at high concentrations, more than 5 wt %.

WO 2008/125203 A1 describes polycarbonate molding materials with UV protection that comprise halogen-containing flame retardants in concentrations which entail a bromine content of >1000 ppm of bromine in the composition as a whole.

U.S. Pat. No. 4,486,560 describes compositions which contain between 0.08 and 0.8 wt % of tri(2,4,6-tribromophenoxy)triazine in combination with N-(p-tolylsulfonyl)-p-toluenesulfonamide. Combination with further sulfonic potassium salts is not described.

JP 11035814 describes compositions comprising polycarbonate and optionally thermoplastic polyesters, 0.2 to 20 wt % of organic, halogen-containing compounds, and fluorinated polyolefins. The compositions, though, contain no flame retardant additives from the class of the class of the alkali metal and/or alkaline earth metal salts of aliphatic and/or aromatic sulfonic acid, sulfonamide, and sulfonimide derivatives.

There is therefore a need for polycarbonate compositions and moldings produced therefrom that exhibit high flame retardancy, in accordance with the standards for use in public edifices/transport, in addition to good optical (transparency/surface) and mechanical properties. This is especially the case for transparent compositions and for transparent products, since the addition of flame retardants at the high concentrations required often has adverse effects on the optical properties of the compositions and of the products produced from them.

Thus, for example, many flame retardant formulations developed for polycarbonate are based on addition of organic and/or inorganic salts, which even when used in small amounts, frequently lead to hazing of the material and thus diminish the transmission of the parts produced. Other flame retardant formulations developed for polycarbonate are based on additions of PTFE (polytetrafluoroethylene) or PTFE blends, for example, which again, at effective concentrations, severely impair the transmission, meaning that only nontransparent moldings are obtained, and which also greatly lower the mechanical properties, particularly toughness of the compositions, with the consequence, for example, that safety and stability are no longer ensured for components under high mechanical load (vibration, for example).

Furthermore, there is likewise a demand for polycarbonate compositions featuring effective flame retardancy, and exhibiting high viscosity, i.e., melt-fluidity, since an increasing flame retardant content has the effect generally of adversely affecting the fluidity of the compositions, possibly leading to problems in the case of large-area components such as seat shells or entire chairs.

In this context it was an object of the present invention, accordingly, to provide compositions and moldings therefrom, and also the use thereof for producing moldings, that exhibit good flame retardancy in accordance with the corresponding fire prevention standards, with—preferably at the same time—high transparency and/or low haze and good mechanical properties, the compositions being preferably halogen-free.

The object above is achieved by compositions as claimed in claim 1 and also by the moldings produced from them, and by the use of the compositions for producing moldings.

The moldings of the invention produced from the compositions meet the Italian standard UNI 9177 (October 1987) class 1 in relation to the flammability of the furnishings of places of public assembly.

In an alternative embodiment, the moldings produced from the compositions meet the Swiss BKZ rating 5.3 relating to the flammability of the furnishings of places of public assembly.

The compositions for producing moldings featuring enhanced fire prevention, in accordance with the present invention, comprise:

A) 96.00 wt % to 99.98 wt % of at least one polycarbonate, preferably 97.20 wt % to 99.59 wt %, more preferably 98.20 wt % to 99.50 wt %, very preferably 98.60 wt % to 99.50 wt %,

B) 0.01 wt % to 1.00 wt %, preferably 0.20 wt % to 0.80 wt %, more preferably 0.30 wt % to 0.60 wt % of one or more mold release agents,

C) 0.01 wt % to 1.00 wt %, more preferably 0.02 wt % to 0.50 wt %, more preferably still 0.10 wt % to 0.20 wt % of one or more heat stabilizers and/or processing stabilizers, preferably selected from the group of phosphines, phosphites and phenolic antioxidants, and also mixtures thereof,

D) optionally 0.00 wt % to 2.00 wt %, preferably from 0.01 wt % to 1.50 wt %, more preferably still 0.10 wt % to 1.0 wt %, and especially preferably 0.10 wt % to 0.60 wt % of at least one or more UV absorbers,

E) optionally 0.00000 wt % to 5.00000 wt %, preferably 0.00001 wt % to 2.50000 wt %, more preferably from 0.00010 wt % to 1.00000 wt %, and very preferably from 0.00050 wt % to 0.50000 wt % of one or more colorants selected from the group of organic and inorganic colorants and carbon black, based on the total amount of the sum of components A-D,

F) optionally 0.0 wt % to 5.0 wt %, preferably 0.01 wt % to 1.00 wt %, of one or more further additives, based on the total amount of the sum of components A-D, components A-L) adding up to 100 wt % and the compositions meeting the requirement of UNI 9177 (October 1987) class 1.

In an alternative embodiment, the compositions meet the requirements of the Swiss BKZ rating 5.3 relating to the flammability of the furnishings of places of public assembly.

In one preferred embodiment, the compositions consist of only components A-C; in a further-preferred embodiment, only of components A-D; and, in a third preferred embodiment, of components A-F.

The compositions of the invention are preferably halogen-free.

In one preferred embodiment, the compositions and products produced therefrom of the present invention are transparent.

In another preferred embodiment, the compositions are free from oligomeric, phosphorus-based flame retardants.

In one preferred embodiment, the molding materials are produced by compounding using single-screw or twin-screw extruders, annular extruders, or planetary roller extruders.

One or more of the preferred embodiments may also be combined with one another.

Surprisingly it has been found that moldings produced from the molding materials equipped by additions of flame retardants in the form of organic salts do not pass the corresponding standardized UNI 9177 class 1 fire classification. Nor have these formulations met the exacting requirements in terms of transmission or transparency.

The compositions of the present invention can be put to advantageous use across a diverse range of applications. Examples of these include applications and moldings in the furniture sector, preferably chairs, tables, shelves, especially furniture which can be permanently installed, panels for architectural or industrial paneling systems or as panels of rail vehicle and aircraft interiors which are each subject to heightened requirements in terms of flame retardancy.

The present invention also relates, furthermore, to the moldings produced from the compositions and also to use of the compositions for producing moldings, that meet the requirements specified in the fire standards.

Component A)

Polycarbonates for the compositions of the invention are homopolycarbonates, copolycarbonates, and thermoplastic, preferably aromatic, polyester polycarbonates, which in the present specification are subsumed under the designation “polycarbonate”.

The homopolycarbonates, copolycarbonates, and polyester carbonates of the invention generally have average molecular weights M̅_{w} (weight average) of 24 000 to 40 000, preferably 26 000 to 35 000, and more preferably of 29 000 to 32 000 (determined by GPC (gel permeation chromatography) with polycarbonate calibration).

On the preparation of polycarbonates for the compositions of the invention, reference may be made, by way of example, to Schnell, “Chemistry and Physics of Polycarbonates”, Polymer Reviews, vol. 9, Interscience Publishers, New York, London, Sydney 1964, to D. C. Prevorsek, B. T. Debona, and Y. Kesten, Corporate Research Center, Allied Chemical Corporation, Morristown, N.J. 07960, “Synthesis of Poly(ester)carbonate Copolymers” in journal of Polymer Science, Polymer Chemistry edition, vol. 19, 75-90 (1980), to D. Freitag, U. Grigo, P. R. Müller, N. Nouvertne, Bayer A G, “Polycarbonates” in Encyclopedia of Polymer Science and Engineering, vol. 11, second edition, 1988, pages 648-718, and lastly to Drs. U. Grigo, K. Kircher and P. R. Müller “Polycarbonates” in Becker/Braun, Kunststoff-Handbuch, volume 3/1, Polycarbonates, Polyacetales, Polyesters, Cellulose esters, Carl Haser Verlag Munich, Vienna 1992, pages 117-299. Preparation takes place preferably by the phase interface process or by the melt transesterification process, and is initially described by way of example for the phase interface process.

Compounds for preferred use as starting compounds are bisphenols of the general formula (1)

HO—Z—OH (1)

in which Z is a divalent organic radical having 6 to 30 carbon atoms that contains one or more aromatic groups.

Examples of such compounds are bisphenols belonging to the group of the dihydroxybiphenyls, bis(hydroxyphenyl)alkanes, indanebisphenols, bis(hydroxyphenyl) ethers, bis(hydroxyphenyl) sulfones, bis(hydroxyphenyl) ketones, and (α,α-bis(hydroxyphenyl)diisopropylbenzenes.

Particularly preferred bisphenols belonging to the above-stated groups of compounds are bisphenol A, tetraalkylbisphenol-A, 4,4-(meta-phenylenediisopropyl)diphenol (bisphenol M), 4,4-(para-phenylenediisopropyl)diphenol, N-phenylisatinbisphenol, 1,1-bis-(4-hydroxyphenyl)-3,3,5-trimethylcyclohexane (BP-TMC), bisphenols of the 2-hydroxycarbyl-3,3-bis(4-hydroxy-aryl)phthalimidine type, more particularly 2-phenyl-3,3-bis(4-hydroxyphenyl)phthalimidine, and also, optionally, mixtures thereof.

Particularly preferred are homopolycarbonates based on bisphenol A and copolycarbonates based on the monomers bisphenol A and 1,1-bis(4-hydroxyphenyl)-3,3,5-trimethylcyclohexane. The bisphenol compounds for use in accordance with the invention are reacted with carbonic acid compounds, more particularly phosgene or, in the case of the melt transesterification process, diphenyl carbonate and/or dimethyl carbonate.

Polyester carbonates are obtained by reacting the aforementioned bisphenols, at least one aromatic dicarboxylic acid, and optionally carbonic acid equivalents. Examples of suitable aromatic dicarboxylic acids are phthalic acid, terephthalic acid, isophthalic acid, 3,3′- or 4,4′-diphenyldicarboxylic acid and benzophenonedicarboxylic acids. A portion, up to 80 mol %, preferably from 20 to 50 mol % of the carbonate groups in the polycarbonates may have been replaced by aromatic dicarboxylic ester groups.

Examples of inert organic solvents used in the case of the phase interface process are dichloromethane, the various dichloroethanes, and chloropropane compounds, tetrachloromethane, trichloromethane, chlorobenzene, and chlorotoluene. Preference is given to using chlorobenzene or dichloromethane and/or mixtures of dichloromethane and chlorobenzene.

The phase interface reaction may be accelerated by catalysts such as tertiary amines, more particularly N-alkylpiperidines, or onium salts. Tributylamine, triethylamine, and N-ethylpiperidine are used preferably. In the case of the melt transesterification process, the catalysts specified in DE-A 42 38 123 are used.

The polycarbonates may be subjected to deliberate and control branching through the use of small amounts of branching agents. Some suitable branching agents are as follows: isatinbiscresol, phloroglucol, 4,6-dimethyl-2,4,6-tri(4-hydroxyphenyl)hept-2-ene; 4,6-dimethyl-2,4,6-tri(4-hydroxyphenyl)heptane; 1,3,5-tri(4-hydroxyphenyl)benzene; 1,1,1-tri(4-hydroxyphenyl)ethane; tri(4-hydroxyphenyl)phenylmethane; 2,2-bis[4,4-bis(4-hydroxyphenyl)cyclohexyl]propane; 2,4-bis(4-hydroxyphenylisopropyl)phenol; 2,6-bis(2-hydroxy-5′-methylbenzyl)-4-methylphenol; 2-(4-hydroxyphenyl)-2-(2,4-dihydroxyphenyl)propane; hexa(4-(4-hydroxyphenyl-isopropyl)phenyl) orthoterephthalic ester; tetra(4-hydroxyphenyl)methane; tetra(4-(4-hydroxyphenyl iso-propyl)phenoxy)methane; α,α′,α″-tris(4-hydroxyphenyl)-1,3,5-triisopropylbenzene; 2,4-dihydroxybenzoic acid; trimesic acid; cyanuric chloride; 3,3-bis(3-methyl-4-hydroxyphenyl)-2-oxo-2,3-dihydroindole; 1,4-bis(4′,4″-dihydroxytriphenyl)methyl)benzene; and, in particular, the following: 1,1,1-tri(4-hydroxyphenyl)ethane and bis(3-methyl-4-hydroxyphenyl)-2-oxo-2,3-dihydroindole.

The 0.05 to 2 mol %, based on diphenols employed, of branching agents or mixtures of the branching agents that are intended for optional accompanying use may be employed together with the diphenols or else added at a later stage in the synthesis.

Chain terminators may be employed. Chain terminators used are preferably phenols such as phenol, alkylphenols such cresol and 4-tert-butylphenol, chlorophenol, bromophenol, cumylphenol, or mixtures thereof, in amounts of 1-20 mol %, preferably 2-10 mol %, per mole of bisphenol. Preference is given to phenol, 4-tert-butylphenol, and/or cumylphenol.

Chain terminators and branching agents may be added separately or else together with the bisphenol to the syntheses.

The polycarbonate preferred in accordance with the invention is bisphenol A homopolycarbonate.

With particular preference the polycarbonate is a polycarbonate, preferably based on bisphenol A, which has been produced by the Bayer phase interface process (evaporation process).

Alternatively polycarbonates of the invention may also be prepared by the melt transesterification process. The melt transesterification process is described in, for example, Encyclopedia of Polymer Science, vol. 10 (1969), Chemistry and Physics of Polycarbonates, Polymer Reviews, H. Schnell, vol. 9, John Wiley and Sons, Inc. (1964) and also in DE-B 10 31 512.

In the case of the melt transesterification process, the aromatic dihydroxy compounds already described in connection with the phase interface process are transesterified with carbonic diesters, with assistance from suitable catalysts and, optionally, further additives in the melt.

Carbonic diesters for the purposes of the invention are those of the formula (2) and 3)

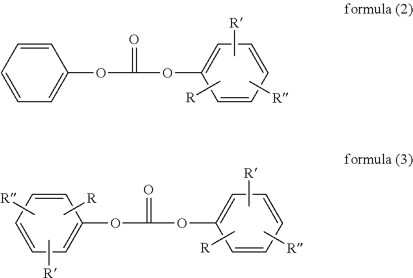

where

R, R′, and R″ independently of one another may be H, optionally branched C₁-C₃₄ alkyl/cycloalkyl, C₇-C₃₄ alkaryl, or C₆-C₃₄ aryl,

examples being

diphenyl carbonate, butylphenyl phenyl carbonate, dibutylphenyl carbonate, isobutylphenyl phenyl carbonate, diisobutyl phenyl carbonate, tert-butylphenyl phenyl carbonate, di-tert-butyl phenyl carbonate, n-pentylphenyl phenyl carbonate, di(n-pentylphenyl) carbonate, n-hexylphenyl phenyl carbonate, di(n-hexylphenyl) carbonate, cyclohexylphenyl phenyl carbonate, di-cyclohexylphenyl carbonate, phenyl phenolphenyl carbonate, diphenylphenol carbonate, isooctylphenyl phenyl carbonate, diisooctylphenyl carbonate, n-nonylphenyl phenyl carbonate, di(n-nonylphenyl) carbonate, cumylphenyl phenyl carbonate, dicumylphenyl carbonate, naphthylphenyl phenyl carbonate, dinaphthylphenyl carbonate, di-tert-butylphenyl phenyl carbonate, di(di-tert-butylphenyl) carbonate, dicumylphenyl phenyl carbonate, di(dicumylphenyl) carbonate, 4-phenoxyphenyl phenyl carbonate, di(4-phenoxyphenyl) carbonate, 3-pentadecylphenyl phenyl carbonate, di(3-pentadecylphenyl) carbonate, tritylphenyl phenyl carbonate, di-tritylphenyl carbonate, preferably diphenyl carbonate, tert-butylphenyl phenyl carbonate, di-tert-butylphenyl carbonate, diphenylphenol carbonate, cumylphenyl phenyl carbonate, di-phenylphenol phenyl carbonate, cumyl phenyl carbonate, more preferably diphenyl carbonate.

Mixtures of the stated carbonic diesters may also be used.

The fraction of carbonic ester is 100 to 130 mol %, preferably 103 to 120 mol %, more preferably 103 to 109 mol %, based on the dihydroxy compound.

Catalysts used in the sense of the invention are basic catalysts described in the melt transesterification process and in the stated literature, such as, for example, alkali metal and alkaline earth metal hydroxides and oxides and also ammonium salts or phosphonium salts, referred to hereinafter as onium salts. Preferred in this context for use are onium salts, more preferably′ phosphonium salts. Phosphonium salts in the sense of the invention are those of the formula (4)

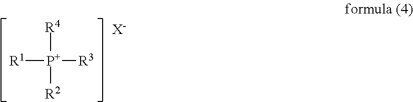

where

R¹⁻⁴ may be the same or different C₁-C₁₀ alkyls, C₆-C₁₀ aryls, C₇-C₁₀ aralkyls, or C₅-C₆ cycloalkyls, preferably methyl or C₆-C₁₄ aryls, more preferably methyl or phenyl, and

X⁻ may be an anion such as hydroxide, sulfate, hydrogensulfate, hydrogencarbonate, carbonate, a halide, preferably chloride, or an alkoxide of the formula OR, where R may be C₆-C₁₄ aryl or C₇-C₁₂ aralkyl, preferably phenyl. Preferred catalysts are

tetraphenylphosphonium chloride, tetraphenylphosphonium hydroxide, tetraphenylphosphonium phenoxide, and more preferably tetraphenylphosphonium phenoxide.

The catalysts are used preferably in amounts of 10⁻⁸ to 10⁻³ mol, relative to one mole of bisphenol, more preferably in amounts of 10⁻⁷ to 10⁻⁴ mol.

Further catalysts may be used alone or, optionally, in addition to the onium salt, in order to increase the rate of the polymerization. They include salts of alkali metals and alkaline earth metals, such as hydroxides, alkoxides, and aryl oxides of lithium, sodium, and potassium, preferably hydroxide salts, alkoxide salts, or aryl oxide salts of sodium. Most preferred are sodium hydroxide and sodium phenoxide.

The amounts of the cocatalyst may be in the range from 1 to 200 ppb, preferably 5 to 150 ppb, and most preferably 10 to 125 ppb, calculated in each case as sodium.

The transesterification reaction of the aromatic dihydroxy compound and the carbonic diester in the melt is carried out preferably in two stages. In the first stage, there is melting of the aromatic dihydroxy compound and of the carbonic diester at temperatures of 80 to 250° C., preferably 100 to 230° C., more preferably 120 to 190° C., under atmospheric pressure, in 0 to 5 hours, preferably 0.25 to 3 hours. Following addition of the catalyst, the oligocarbonate is produced from the aromatic dihydroxy compound and from the carbonic diester, by application of reduced pressure (down to a pressure of 2.6 mbar in the apparatus) and increasing the temperature (down to 260° C.) by distillative removal of monophenol. In this case, the major amount of vapors from the process are obtained. The oligocarbonate thus prepared has an average molar mass by weight, Mw (determined by measuring the relative solution viscosity in dichloromethane or in mixtures of equal amounts by weight of phenol/0-dichlorobenzene, calibrated by light scattering) in the range from 2000 g/mol to 18 000 g/mol, preferably from 4000 g/mol to 15 000 g/mol.

In the second stage, in the polycondensation, the polycarbonate is prepared by further increasing the temperature to 250 to 320° C., preferably 270 to 295° C., under a pressure of <2.6 mbar, with the remaining vapors being removed from the process.

The catalysts may also be used in combination (two or more) with one another.

If using alkali/alkaline earth metal catalysts, the alkali/alkaline earth metal catalysts are preferably added at a later point in time (for example, after the oligocarbonate synthesis, during the polycondensation in the second stage).

In the sense of the process of the invention, the reaction of the aromatic dihydroxy compound and the carbonic diester to form the polycarbonate may be carried out batchwise or, preferably, continuously, as for example in stirred tanks, thin-film evaporators, falling-film evaporators, stirred tank cascades, extruders, compounders, simple disk reactors, and high-viscosity disk reactors.

In analogy to the phase interface process, branched polycarbonates or copolycarbonates may be prepared by use of polyfunctional compounds.

Besides polycarbonates, the compositions of the invention preferably contain no other plastics such as aromatic polyesters such as polybutylene terephthalate or polyethylene terephthalate, polyamides, polyimides, polyesteramides, polyacrylates, and polymethacrylates, such as polyalkyl(meth)acrylates, for example, and more particularly polymethyl methacryate, polyacetals, polyurethanes, polyolefins, halogen-containing polymers, polysulfones, polyethersulfones, polyetherketones, polysiloxanes, polybenzimidazoles, urea-formaldehyde resins, melamine-formaldehyde resins, phenol-formaldehyde resin, alkyd resins, epoxy resins, polystyrenes.

As an exception to this, the compositions of the invention may comprise PMMA (polymethyl methacrylate) in order to exert a favorable influence on the optical properties, especially the transmission.

One specific embodiment comprises, in this context, a mixture of polycarbonate and PMMA with less than 0.5 wt %, preferably less than 0.3 wt %, more preferably less than 0.1%, comprising at least 0.01% of PMMA, based on the amount of polycarbonate, with the PMMA preferably having a molar weight<40 000 g/mol. In one particularly preferred embodiment, the fraction of PMMA is 0.2% and more preferably 0.1%, based on the amount of polycarbonate, with the PMMA preferably having a molar weight<0.40 000 g/mol.

Component B)

The polymer compositions of the invention may optionally comprise mold release agents. Particularly suitable mold release agents for the composition of the invention are pentaerythritol tetrastearate (PETS); glycerol monostearate (GMS), stearyl stearate, or linear esters of linear fatty acids such as, for example, stearic acid, margaric acid, palmitic acid, myristic acid, lauric acid, and capric acid, esterified with fatty alcohols such as, for example, lauryl alcohol, myristyl alcohol, cetyl alcohol, and lauryl alcohol, and also mixtures of two or more of these esters. Preference is given to using stearyl stearate, PETS, and GMS, and also mixtures thereof. Particularly preferred is a mixture of PETS and GMS.

Component C)

In one preferred embodiment the polymer composition comprises heat stabilizers and/or processing stabilizers. Of preferential suitability are phosphites and phosphonites and also phosphines. Examples are triphenyl phosphite, diphenyl alkyl phosphite, phenyl dialkyl phosphite, tris(nonylphenyl) phosphite, trilauryl phosphite, trioctadecyl phosphite, distearylpentaerythritol diphosphite, tris(2,4-di-tert-butylphenyl)phosphite, diisodecylpentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)-pentaerythritol diphosphite, bis(2,4,6-tris(tert-butylphenyl)pentaerythritol diphosphite, tristearylsorbitol triphosphite, tetrakis(2,4-di-tert-butylphenyl)-4,4′-biphenylene diphosphonite, 6-isooctyloxy-2,4,8,10-tetra-tert-butyl-12H-dibenzo[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenzo[d,g]-1,3,2-dioxaphosphocin, 2,2′,2″-nitrilo-[triethyl-tris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, bis(2,6-di-ter-butyl-4-methylphenyl)pentaerythritol diphosphite, triphenylphosphine (TPP), trialkylphenylphosphine, bisdiphenylphosphinoethane, or a trinaphthylphosphine. Especially preferred for use are triphenylphosphine (TPP), Irgafos® 168 (tris(2,4-di-tert-butylphenyl)phosphite), and tris(nonylphenyl) phosphite, or mixtures thereof.

Furthermore, use may be made of phenolic antioxidants such as alkylated monophenols, alkylated thiolalkylphenols, hydroquinones, and alkylated hydroquinones. Particularly preferred for use are Irganox® 1010 (pentaerythritol 3-(4-hydroxy-3,5-di-tert-butylphenyl)propionate; CAS: 6683-19-8) and Irganox 1076® (2,6-di-tert-butyl-4-(octadecanoxycarbonylethyl)phenol).

Particularly preferred is Irganox® B900 (mixture of 80% Irgafose® 168 and 20% Irganox® 1076; BASF AG; Ludwigshafen).

In one specific embodiment of the present invention, the phosphine compounds of the invention are used together with phosphite or a phenolic antioxidant or with a mixture of the two last-mentioned compounds.

Component D)

In one preferred embodiment, the polymer composition of the invention further comprises an ultraviolet absorber. Ultraviolet absorbers suitable for use in the polymer composition of the invention are compounds which have a minimal transmittance below 400 nm and a maximum transmittance above 400 nm. Such compounds and their preparation are known from the literature and described in EP-A 0 839 623, WO-A 96/15102, and EP-A 0 500 496, for example. Ultraviolet absorbers particularly suitable for use in the composition of the invention are benzotriazoles, triazines, benzophenones, and/or arylated cyanoacrylates.

Particularly suitable ultraviolet absorbers are hydroxyl-benzotriazoles, such as 2-(3′,5′-bis-(1,1-dimethylbenzyl)-2′-hydroxyphenyl)benzotriazole (Tinuvin® 234, Ciba Spezialitätenchemie, Basel), 2-(2′-hydroxy-5′-(tert-octyl)phenyl)benzotriazole (Tinuvin® 329, Ciba Spezialitätenchemie, Basel), 2-(2′-hydroxy-3′-(2-butyl)-5′-(tert-butyl)phenyl)benzotriazole (Tinuvin® 350, Ciba Spezialitätenchemie, Basel), bis-(3-(2H-benzotriazolyl)-2-hydroxy-5-tert-octyl)methane, (Tinuvin® 360, Ciba Spezialitätenchemie, Basel), (2-(4,6-diphenyl-1,3,5-triazin-2-yl)-5-(hexyloxy)phenol (Tinuvin® 1577, Ciba Spezialitätenchemie, Basel), and also the benzophenones 2,4-dihydroxy-benzophenone (Chimasorb® 22, Ciba Spezialitätenchemie, Basel) and 2-hydroxy-4-(octyloxy)-benzophenone (Chimasorb® 81, Ciba, Basel), 2-propenoic acid, 2-cyano-3,3-diphenyl-, 2,2-bis[[(2-cyano-1-oxo-3,3-diphenyl-2-propenyl)oxy]methyl]-1,3-propanediyl ester (9CI) (Uvinul® 3030, BASF AG Ludwigshafen), 2-[2-hydroxy-4-(2-ethylhexyl)oxy]phenyl-4,6-di(4-phenyl)phenyl-1,3,5-triazine (CGX UVA 006, Ciba Spezialitätenchemie, Basel) or tetraethyl 2,2′-(1,4-phenylenedimethylidene)bismalonate (Hostavin® B-Cap, Clariant AG).

Mixtures of these ultraviolet absorbers may also be used.

As far as the amount of ultraviolet absorber present in the composition is concerned, there are no particular restrictions, provided the desired absorption of UV radiation and also, optionally, sufficient transparency in the molding produced from the composition are ensured.

Component E)

In accordance with the invention, organic colorants from the group of the organic pigments and dyes, inorganic pigments, and carbon black may be used.

Preferred organic pigments are, for example, phthalocyanine-derived dyes such as copper phthalocyanine blue and copper phthalocyanine green, fused polycyclic dyes and pigments such as azo-based (e.g. nickel azo yellow), sulfur indigo dyes, perinon-based, perylene-based, quinacridone-derived, dioxazine-based, isoindolinone-based, and quinophthalone-derived derivatives, anthraquinone-based heterocyclic systems, etc. Of these, cyanine derivatives, quinoline derivatives, anthraquinone derivatives, and phthalocyanine derivatives are preferred. They are available as commercial product, e.g., as MACROLEX Blue RR®, MACROLEX Violett 3R®, MACROLEX Violett B® (Lanxess AG, Germany), Sumiplast Violett RR, Sumiplast Violett B, Sumiplast Blue OR, (Sumitomo Chemical Co., Ltd.), Diaresin Violett D, Diaresin Blue G, Diaresin Blue N (Mitsubishi Chemical Corporation), Heliogen Blue or Heliogen Green (BASF AG, Germany). Inorganic pigments used may be, for example, titanium dioxide, zinc oxide, barium sulfate, and/or iron oxides.

Organic flame retardants or organic salts which are not present in the compositions of the present invention, among others alkali metal salts and/or alkaline earth metal salts of aliphatic and/or aromatic sulfonic acid, sulfonamide, and sulfonimide derivatives, examples being potassium perfluorobutanesulfonate, potassium diphenylsulfonylsulfonate, N-(p-tolylsulfonyl)-p-toluenesulfimide potassium salt, N—(N′-benzylaminocarbonyl)sulfanylimide potassium salt, sodium or potassium perfluorobutanesulfate, sodium or potassium perfluoromethanesulfonate, sodium or potassium perfluorooctanesulfate, sodium or potassium 2,5-dichlorobenzenesulfate, sodium or potassium 2,4,5-trichlorobenzenesulfate, sodium or potassium methylphosphonate, sodium or potassium (2-phenylethylene)phosphonate, sodium or potassium pentachlorobenzoate, sodium or potassium 2,4,6-trichlorobenzoate, sodium or potassium 2,4-dichlorobenzoate, phenylphosphonate, sodium or potassium diphenylsulfonylsulfonate, sodium or potassium 2-formylbenzenesulfonate, sodium or potassium (N-benzenesulfonyl)benzenesulfonamide. Trisodium or tripotassium hexafluoroaluminate, disodium or dipotassium hexafluorotitanate, disodium or dipotassium hexafluorosilicate, disodium or dipotassium hexafluorozirconate, sodium or potassium pyrophosphate, sodium or potassium metaphosphate, sodium or potassium tetrafluoroborate, sodium or potassium hexafluorophosphate, sodium or potassium or lithium phosphate, N-(p-tolylsulfonyl)-p-tolenesulfimide potassium salt, and N—(N′-benzylaminocarbonyl)sulfanylimide potassium salt, and also mixtures thereof included.

With particular preference the composition is free from potassium nona-fluoro-1-butanesulfonate (e.g. Bayowet® C4; Firma Lanxess, Leverkusen, Germany, CAS No. 29420-49-3).

Component F)

The polycarbonate compositions of the invention and also any further plastics present may be further admixed with the additives customary for these thermoplastics, selected from the group of the antistats and flow improvers.

Preferred antistats are those as described in EP 1 290 106 and EP 1 210 388, more particularly those based on quaternary ammonium salts of a perfluoroalkylsulfonic acid.

Compounds of these kinds are described in, for example, WO 99/55772 A1, pp. 15-25, EP 1 308 084, and in the corresponding chapters of the “Plastics Additives Handbook”, edited by Hans Zweifel, 5^{th} edition 2000, Hanser Publishers, Munich.

Production of the Compositions:

The compositions of the invention are produced with commonplace incorporation techniques, accomplished for example by mixing solutions of components B)-F) with a solution of polycarbonate (component A)) in suitable solvents such as dichloromethane, haloalkanes, haloaromatics, chlorobenzene, and xylenes. The mixtures of substances are then homogenized preferably in a known way by extrusion. The solution mixtures are preferably worked up in a known way—compounded, for example—by evaporation of the solvent and subsequent extrusion.

Moreover, the composition may be mixed, and subsequently extruded, in customary mixing devices such as screw extruders (for example, twin-screw extruders, ZSK, planetary roller extruders, annular extruders), compounders, Brahender or Banbury mills. Following extrusion, the extrudate may be cooled and comminuted. It is also possible for individual components to be premixed and then added individually, and/or likewise as mixtures, to the rest of the starting materials.

The compositions of the invention may be worked up in a manner known to the skilled person and processed to form any desired shaped articles, by means for example of extrusion, injection molding, rotor molding, or extrusion blow molding, particular preference being given to injection molding and rotor molding.

In the case of production of coextruded moldings in accordance with the present invention, the polycarbonate pellets of the base material are supplied to the filling hopper of the main extruder, and the coextrusion material is supplied to that of the coextruder. In the respective barrel/screw plasticizing system, each material is melted and conveyed. The two material melts are combined in the coextrusion adapter and, after leaving the die and cooling, form a composite. The rest of the units serve for transport, cutting to length, and laydown of the extruded panels.

Panels without a coextruded layer are produced correspondingly, by either not operating the coextruder or charging it with the same polymer composition as the main extruder.

The blow molding of polycarbonate is described in more detail in, for instance, DE 102 29 594 and references cited therein.

Moldings in the sense of the present invention are in particular as follows:

Furniture, preferably transparent and/or translucent and/or nontransparent forms such as, for example, sofas, chairs such as, for example, stacking chairs, office chairs, highchairs, dining table chairs, and chairs with lay-down and lay-up elements, seat shells, stools, such as, for example, bar stools, benches, couches, tables such as, for example, occasional tables, conference tables, dining tables, tables for standing, and kitchen tables, counters such as, for example, reception counters, bar counters, and kitchen counters, shelving units, shelf inserts, lighting systems such as, for example, lamps, multidimensional wall elements, cupboards such as, for example, office cupboards and kitchen cupboards, kitchen elements such as, for example, fume hoods, splash protectors, washbasins, refrigerator elements, and flipcharts.

Articles in the sense of the invention are also roller blinds, venetian blinds, and shutters.

Articles in the sense of the invention are also decorative elements such as, for example, vases, frames, flower pots and decorative stripes.

Articles in the sense of the invention are also signs such as, for example, safety signs and warning signs.

The articles may be in a variety of design forms, such as, for example, circular, angular, solid, hollow, oval, internally lit, and externally lit.

The articles are used in public facilities such as, for example, theatres, cinemas, philharmonic halls, operas, concert halls, discotheques, casinos, museums, administrative buildings, banks, sport stadia, airports, rail stations, hospitals, schools, universities, and prisons.

The articles are suitable for interior and exterior use.

With particular preference, moldings in accordance with the present invention are chairs and seat shells.

The transparent moldings produced from the compositions of the invention preferably have wall thicknesses of 1 mm to 15 mm, more preferably of 2 mm to 12 mm, and very preferably of 4 mm to 10 mm.

With particular preference the moldings, up to a wall thickness of 4 mm, have a light transmittance (measured according to ISO 13468-2) of >83%, preferably of >85%, and very preferably of >87%.

The compositions of the invention comprise preferably polycarbonate-soluble colorants in a fraction of 100 ppm, more preferably <50 ppm, and very preferably <20 ppm.

In one preferred embodiment, the moldings produced from the compositions of the invention have a scratch-resistant coating at least on one side, preferably on both sides.

In an alternative embodiment, the compositions and moldings produced therefrom are nontransparent or translucent, in which case they have wall thicknesses of 1 mm to 15 ruin, preferably 2 mm to 12 mm, very preferably from 4 mm to 10 mm.

Flame Retardancy Tests

For the classification of construction materials in Italy there are two test methods employed.

In the case of the test method according to UNI 8457 (October 1987), the testing takes place in a combustion box set out free from draughts. In this case, a burner flame 20 mm long is directed for 30 seconds onto the sample surface, which is arranged vertically. In each case 10 samples of dimensions of (340*104*sample thickness) mm, which have been stored for at least 24 hours at 23° C./50% relative humidity, are tested. Anisotropic samples shall be tested in the longitudinal and transverse directions. Corresponding to the after burn time, the afterglow time, the length of sample destroyed, and the dripping characteristics, three specimens are tested in dimensions of 800*155*sample thickness (<100) [mm].

For the test method according to UNI 9174 (October 1987), in each case 3 test specimens in dimensions of (800*155*sample thickness) mm in longitudinal and transverse direction are required.

In the test, the lateral flame spread is ascertained on exposure to a radiation source. In this case the samples are positioned in front of the radiant source, in wall, ceiling or floor arrangement. The material is assigned a category according to rate of flame spread, area damaged, afterglow time, and dripping characteristics.

The classification is according to UNI 9177 (October 1987), with the class of the construction material being specified from the combination of the two categories achieved in UNI 8457 and in UNI 9174.

Rheological Properties:

The melt volume rate (MVR) of flow is determined to ISO 1133 at a temperature of 300° C. with a weight of 1.2 kg.

Optical Measurements:

The haze and transmittance determinations (transparency) took place on panels with geometry of 60*40*4 mm³ according to ISO 13468.

### EXAMPLES

### Production of the Compositions

The compositions according to the present invention one compounded in apparatus comprising the following: a metering means for the components, a corotating twin-screw extruder (ZSK 25 from Werner & Pfleiderer) with a screw diameter of 25 mm, a perforated die for forming melt strands, a waterbath for cooling and for solidification of the strands, and a pelletizer.

The compositions of examples 1 and 2 (comparative example) were produced in the compounding apparatus described above, using the following components:

Component A)

Makrolon® 3200 is a polycarbonate available commercially from Bayer MaterialScience AG. The melt volume rate (MVR) of flow according to ISO 1133 is 4 cm³/(10 min) at 300° C. and 1.2 kg loading.

Makrolon® 3100 is a polycarbonate available commercially from Bayer MaterialScience AG. The melt volume rate (MVR) of flow according to ISO 1133 is 6 cm³/(10 min) at 300° C. and 1.2 kg loading.

Component B)

Loxiol® VPG 861 is a pentaerythritol tetrastearate available commercially from Cognis AG.

Component C)

Irganox® 1076 (CAS number 2082-79-3) is a monofunctional, sterically hindered phenol available commercially from Ciba AG, belonging to the group of the phenolic antioxidants ((2,6-di-tert-butyl-4-(octadecanoxycarbonylethyl)phenol)).

Flame Retardant Comparative Test:

C4, Bayowet® C4 is a potassium nona-fluoro-1-butanesulfonate obtainable commercially from Lanxess AG.

The compounded formulation of example 1 is produced by melting Makrolon 3200 and metering 5 wt % 0 of a powder mixture consisting of Makrolon® 3100 powder with 0.45 wt % of PETS, 0.25 wt % of Tinuvin 329, and 0.01 wt % of Irganox 1076, the amounts in wt % adding up to 100% and being based on the weight of the composition as a whole (Makrolon 3200 adds up to 100 wt %), via a metering balance into the twin-screw extruder.

The compounded formulation of comparative example 2 is produced by melting Makrolon 3200 and metering 5 wt % of a powder mixture consisting of Makrolon® 3100 powder with 0.45 wt % of PETS, 0.25 wt % of Tinuvin 329, 0.01 wt % of Irganox 1076, and 0.08 wt % of Bayowet® C4 the amounts in wt % adding up to 100% and being based on the weight of the composition as a whole (Makrolon 3200 adds up to 100 wt %), via a metering balance into the twin-screw extruder.

The compounded formulations of examples 1 and 2 (comparative example) are subsequently processed to form specimens for flame retardancy measurements.

For the UNI 8457 test, in each case 10 panels with geometry of 340 mm*104 mm and 6 min thickness are fabricated.

For the UNI 9174 test, in each case 3 panels geometry of 800 mm*155 mm and 6 mm thickness are fabricated.

For optical measurements, in each case 10 panels with geometry of 60 mm*40 mm and 4 mm thickness are fabricated.

### Examples

### Components A

A1: Linear polycarbonate based on bisphenol A with an MVR=4.1 cm³/10 min (Makrolon 3200)

A2: Linear polycarbonate based on bisphenol A with an MVR=6.2 cm³/10 min (Makrolon 3100)

### Components B

Pentaerythritol tetrastearate as lubricant/mold release agent

### Components C

Irganox 1076

### Components D

Tinuvin 329 (UV absorber)

Comparative Test:

Bayowet® C4 as flame retardancy additive

TABLE 1
Test data

| | | | | 2 (com- |
|---|---|---|---|---|
| Components | wt % | | 1 | parative) |
| A1 | | | 94.20 | 94.12 |
| A2 | | | 5.00 | 5.00 |
| B | | | 0.45 | 0.45 |
| D | | | 0.25 | 0.25 |
| C | | | 0.10 | 0.10 |
| Flame retardant | | | — | 0.08 |
| Total | | | 100.00 | 100.00 |
| Properties | Units | Standard | | |
| Vicat B 120 | [° C.] | ISO 306 | 145 | 145 |
| Fire behavior | Class 1 | UNI 9177 | Passed | Failed |
| MVR 300/1.2 kg | [ccm/10 min] | ISO 1133 | 5.8 | 6.5 |
| Light transmittance | % | ISO 13468-2 | 86.2 | 83.3 |

1.-10. (canceled)

11. A process to produce a molding which passes the UNI 9177 class 1 requirement and/or the requirement of the Swiss BKZ rating 5.3 which comprises compounding a composition comprising:
A) 96.00 wt % to 99.98 wt % of at least one polycarbonate,
B) 0.01 wt % to 1.00 wt % of one or more mold release agents,
C) 0.01 wt % to 1.00 wt % of one or more heat stabilizers and/or processing stabilizers,
D) 0.00 wt % to 2.00 wt % of at least one or more UV absorbers,
E) 0.00000 wt % to 5.00000 wt % of one or more colorants selected from the group of organic and inorganic colorants and carbon black, based on the total amount of the sum of components A-D,
F) 0.0 wt % to 5.0 wt % of one or more further additives, different from components B)-E), based on the total amount of the sum of components A-D,
the components A-D adding up to 100 wt %, and
where the composition is free from phosphorus-based flame retardants, from alkali metal and alkaline earth metal salts of aliphatic and aromatic sulfonic acid, sulfonamide and sulfonimide derivatives, sodium or potassium pentachlorobenzoate, sodium or potassium 2,4-dichlorobenzoate, sodium or potassium 2,4,6-trichlorobenzoate, trisodium or tripotassium hexafluoroaluminate, disodium or dipotassium hexafluorotitanate, disodium or dipotassium hexafluorosilicate, disodium or dipotassium hexafluorozirconate, sodium or potassium tetrafluoroborate.

12. The process as claimed in claim 11, wherein component C) is selected from the group of phosphines, phosphites, and phenolic antioxidants and also mixtures thereof.

13. The process as claimed in claim 11, wherein the composition is halogen-free.

14. The process as claimed in claim 11, wherein the composition is free from phosphorus based flame retardants.

15. The process as claimed in claim 11, wherein the polycarbonate has an average molecular weight M̅_{w} of 29 000 to 32 000 g/mol.

16. The process as claimed in claim 11, wherein component B) is a mixture of pentaerythritol tetrastearate and glycerol monostearate.

17. The process as claimed in claim 11, wherein the composition has a light transmittance of at least 83%, measured according to ISO 13468-2.

18. The process as claimed in claim 11, wherein the composition is translucent or nontransparent, measured according to ISO 13468.

19. A molding with enhanced flame retardancy, meeting at least one standard from the group of UNI 9177 class 1 and the Swiss BKZ rating 5.3, produced from a composition comprising
A) 96.00 wt % to 99.9 wt % of at least one polycarbonate,
B) 0.01 wt % to 1.00 wt % of one or more mold release agents,
C) 0.01 wt % to 1.00 wt % of one or more heat stabilizers and/or processing stabilizers,
D) 0.00 wt % to 2.00 wt % of at least one or more UV absorbers,
E) 0.00000 wt % to 5.00000 wt % of one or more colorants selected from the group of organic and inorganic colorants and carbon black, based on the total amount of the sum of components A-D,
F) 0.0 wt % to 5.0 wt % of one or more further additives, different from components B)-E), based on the total amount of the sum of components A-D,
the components A-D adding up to 100 wt %, and
where the composition is free from phosphorus-based flame retardants, from alkali metal and alkaline earth metal salts of aliphatic and aromatic sulfonic acid, sulfonamide and sulfonimide derivatives, sodium or potassium pentachlorobenzoate, sodium or potassium 2,4-dichlorobenzoate, sodium or potassium 2,4,6-trichlorobenzoate, trisodium or tripotassium hexafluoroaluminate, disodium or dipotassium hexafluorotitanate, disodium or dipotassium hexafluorosilicate, disodium or dipotassium hexafluorozirconate, sodium or potassium tetrafluoroborate.

20. The molding as claimed in claim 19, wherein the molding is a chair or a seat shell.

21. The molding as claimed in claim 19, wherein component C) is selected from the group of phosphines, phosphites, and phenolic antioxidants and also mixtures thereof.

22. The molding as claimed in claim 19, wherein the composition is halogen-free.

23. The molding as claimed in claim 19, wherein the composition is free from phosphorus-based flame retardants.

24. The molding as claimed in claim 19, wherein the polycarbonate has an average molecular weight M̅_{w} of 29 000 to 32 000 g/mol.

25. The molding as claimed in claim 19, wherein component B) is a mixture of pentaerythritol tetrastearate and glycerol monostearate.

26. The molding as claimed in claim 19, wherein the composition has a light transmittance of at least 83%, measured according to ISO 13468-2.

27. The molding as claimed in claim 19, wherein the composition is translucent or nontransparent, measured according to ISO 13468.
